(19) United States
(12) Patent Application Publication
(10) Pub. No.: US 2013/0160052 A1
(43) Pub. Date: Jun. 20, 2013

(54) SYSTEM AND METHOD FOR INTERACTIVE COMMUNICATION WITH A MEDIA DEVICE USER SUCH AS A TELEVISION VIEWER

(71) Applicant: Michael J. Ure, Cupertino, CA (US)

(72) Inventor: Michael J. Ure, Cupertino, CA (US)

(21) Appl. No.: 13/526,478

(22) Filed: Jun. 18, 2012

Related U.S. Application Data
(63) Continuation of application No. 12/605,463, filed on Oct. 26, 2009, now abandoned.

(51) Int. Cl. H04N 21/43

(52) U.S. Cl. CPC H04N 21/43
USPC 725/34

(57) ABSTRACT

A personalized television or internet video viewing environment, where the user can respond to messages. Messages are received over the internet and overlaid onto the video program. A light and vibrator on the remote control alert the viewer to respond by speaking into a microphone in the remote control unit. Voice recognition techniques are used to interpret the user's response, and biometric voice analysis can be used to identify the user. Successive interactions can be related and tailored to the particular user.

### FIELD OF THE INVENTION

The present invention generally relates to the application of interactive internet and computer services during a television or other media presentation session to a user.

### BACKGROUND OF THE INVENTION

A number of efforts have been made to improve the convenience of a number of computer-and-human communication tasks, and to customize and target television programming to a particular customer.

Goldband, et al., (U.S. Pat. No. 6,434,532) teach how computer programs can use the internet to communicate usage information about computer applications to aid in customer support, marketing, or sales to a specific customer. Sessions can be personalized, so that information from current sessions can be based, at least in part, on previous sessions for the same user, helping to focus the customer support or advertising or other communications to a particular user.

Choi, et al., (US 2005/0049862) teach how a user can provide audio input, such as into a remote control device, to receive personalized services from an audio/video system. Voice identification can be used to target individualized preferences, and interpreted commands can be used to filter for particular programming genres, or to show a specific program.

Massimi (US 2009/0217324) teaches how a voice authentication system can be used to customize television content.

Despite these prior teachings, there remains an unfulfilled opportunity for an internet and voice-response communication system.

### SUMMARY

The present invention is defined by the following claims, and nothing in this section should be taken as a limitation on those claims. By way of introduction, the embodiment described below provides for personalized viewer interaction in an Internet Protocol (IP) television (TV) environment or an environment with a non-IP program delivery together with a supplemental internet connection. Interaction is bi-directional with communication toward the viewer being, in one enbodiment, visual via a video-text-like bar. Communication from the viewer toward the TV headend is via voice. For this purpose, a TV remote control is used with a microphone and a radio transceiver. The remote may also include a vibrator, to notify the user of a request for a response. A microphone in the remote control is activated, and the user's voice is transmitted to a transceiver in a box near the TV or video monitor for further transmission to a headend for processing. A light, such as an LED, can also be activated on the remote control unit when a response is being requested. Sound level thresholding may be used to isolate the voice of the user from other spurious sounds that the microphone may pick up. Additionally, the signals from multiple microphones in different locations on the remote control unit may be used to isolate the user's voice from other ambient sounds in the room, such as from the television set. At the headend, voice recognition is used to interpret the viewer response. Verbal responses are transmitted to the headend in real time. Message content may be transmitted from the headend during off-peak hours. Voice recognition at the headend may be used to recognize the voice identities of specific viewers. Successive interactions may be related and tailored to a specific user. Biometric voice authentication may be applied to extend the system to security-sensitive applications such as electronic voting.

In this way, viewers watching TV can conveniently participate in two-way communication using the internet. They can verbally respond to a poll, make purchases, request additional advertising or marketing materials, or carry on a conversation with others, such as friends or family members who may be watching a same sporting event. They may speak into their remote control to drive, in full or in part, a sporting event where plays are selected based on real-time internet-facilitated polling. In short, the invention provides a means for a TV to listen to the viewer.

Additional features and benefits of the present invention will become apparent from the detailed description, figures and claims set forth below.

### BRIEF DESCRIPTION OF THE DRAWINGS

The present invention may be further understood from the following description in conjunction with the appended drawings. In the drawings:

FIG. 1 is a block diagram of an embodiment of a viewing system with a television and a supplemental internet connection;

FIG. 2 is a block diagram of an embodiment of a viewing system in an internet protocol television environment;

FIG. 3 is a flowchart diagram illustrating one embodiment of the processing in the remote control unit;

FIG. 4 is a flowchart diagram illustrating one embodiment of the processing in the set-top, or local, processer; and

FIG. 5 is a flowchart diagram illustrating one embodiment of the processing in the remote, or headend processor.

### DETAILED DESCRIPTION

Television viewing has historically been a one-way communication channel, with a viewer passively watching and listening, with no opportunity for the viewer to conveniently respond to what is being presented. The embodiments described below describe how a television viewing system including a remote control device with a microphone can be used to enable a viewer to communicate back. Any of a large number of applications may be enabled by this system. For example, at the end of a commercial for a particular product, a viewer could be asked if he or she would like to have more information about the product mailed to his or her home, or if they would like to initiate a purchase of the product immediately. In another application, viewers watching a sporting event could provide input, via the internet, to a team's manager or coach to direct upcoming plays. In another application, a viewer could be asked to participate in a poll. In another application, the viewer's voice could be transmitted over the internet to another location, allowing him or her to carry on a conversation while watching a television, including with others who may be watching the same or a different program at a different location. Voice authentication can be used to verify the identity of the speaker, allowing the system to be used for security-sensitive applications, such as electronic voting. Successive interactions may be related and tailored so as to establish, in effect, a running personalized dialog; for example, a set of interactions may have a goal to incentivize a viewer to test drive a particular car model. Another application is opinion polls. Instead of logging onto the internet to participate, a user can voice his or her opinion vocally and immediately. In this instance, the poll question may already be present in the program as it delivered without the need for message insertion. In other respects, operation may be the same as or similar to that of other applications as described herein.

Throughout this description, wherever the term “video” is used, it should be understood that the video may be accompanied by an audio component, and may consist of only an audio component, such as in the case of a radio station that is broadcast as a cable television program. In the case of an audio program, user-directed messages may be presented visually.

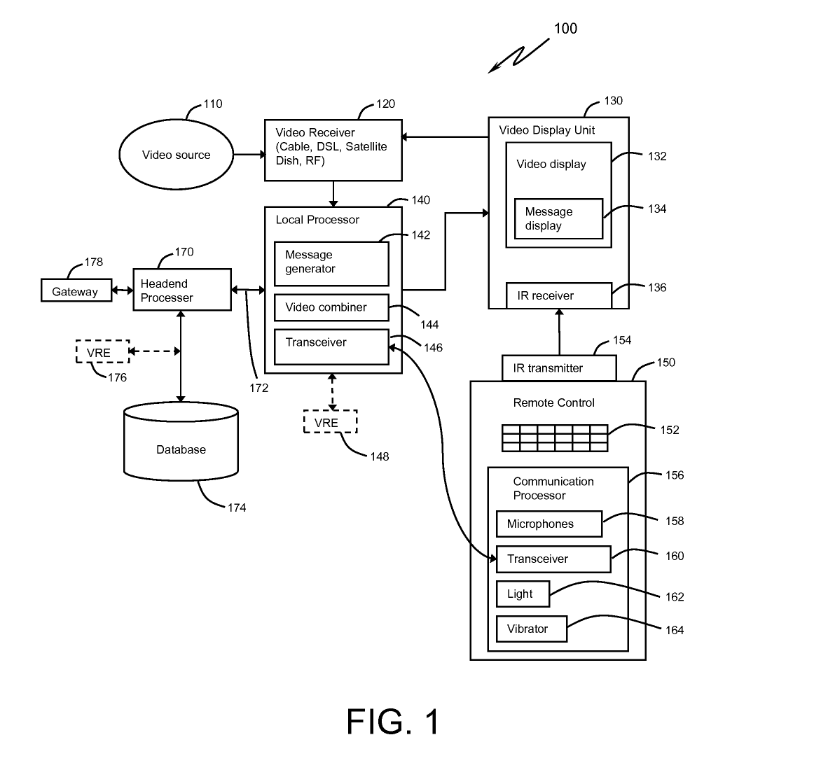

FIG. 1 shows one embodiment of a system 100 that enables viewer interactions. The system includes a video source 110, a video receiver 120, a video display unit 130, a local processor 140, a remote control 150, a headend processor 170, an internet connection 172 and a database 174.

The video source 110 represents any transmitter of video signals, which in one embodiment is a television station.

The video receiver 120 receives the video signal and comprises a processor or other means for converting the video signal to a format that can be displayed. The video may come from any of a number of sources, including cable, digital subscriber line (DSL), a satellite dish, conventional radio-frequency (RF) television, or any other presently known or not yet know means of conveying a video signal. The signal that the video receiver 120 obtains may be analog or digital.

The video display unit 130 comprises a video display 132 with a screen and speakers, or an acoustic output that can be connected to speakers. It may be a television, a computer monitor, or any other screen or video projection system that shows a sequence of images. A portion of the video display is used as a message display 134 region. The message display 134 may be limited to a small bar near the bottom of the screen, comprising approximately 10% to 20% of the height of the video display 134 or may encompass a smaller or larger portion of the display, including all of it. The video display unit 130 also contains an infrared (IR) receiver 136.

The local processor 140 comprises a digital signal processor, general processor, ASIC or other analog or digital device. The local processor includes a message generator 142 a video combiner 144 and a radio-frequency transceiver 146 The local processor 140 may be a single processor, or a series of processors.

The local processor 140 may be coupled to an optional voice recognition engine, or voice recognizer, 148. The voice recognizer 148 may be dynamically programmed based on message-specific vocabulary transmitted with a message. Local voice recognition may permit text instead of actual voice data to be transmitted in the reverse direction (the forward direction being communication to the user). The text may correspond directly to a spoken voice response or may correspond only indirectly. For example, if an opinion poll presents choices A-D, if the user speaks information corresponding to choice A, instead of transmitting the corresponding text, only the letter A may be transmitted.

The local processor 140 receives the video signal from the video receiver 120 and uses the message generator 142 to format the message to be displayed into a video format, such as text of a particular size and font and color, which may be stationary or moving from frame to frame. The message may also include pictures or animations. The video combiner 144 combines the message video with the video from the video receiver to generate a single video presentation. The message video may be overlaid on the other video opaquely, or may be combined with some level of transparency. Other combination techniques may be used. The local processor 140 may be contained in a separate box from the video receiver 120 or both may be contained within the same box.

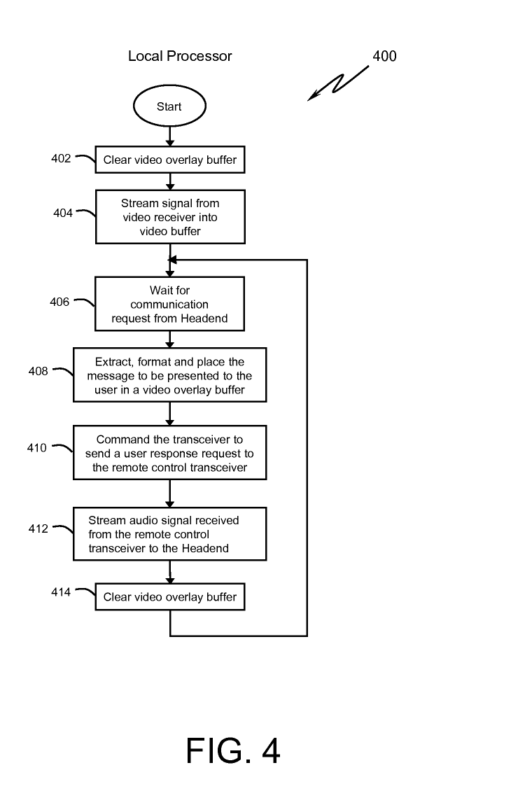

In one embodiment, the local processor 140 implements the algorithm discussed below with respect to FIG. 4, but different algorithms may be implemented.

The remote control 150 includes buttons 152, an infrared (IR) transmitter 154, a communication processor 156, one or more microphones 158, a radio-frequency transceiver 160 and optionally one or more of a light 162, such as a light emitting diode (LED), and a vibrator 164.

The communication processor 156 comprises a digital signal processor, processor, ASIC or other device for processing a request for user-directed communication (the request being received by the transceiver 160); controlling the microphones 158, light 162, and vibrator 164; identifying the audio response picked up by the microphones 158 and passing this information to the transceiver 160 to be sent back to the local processor 140.

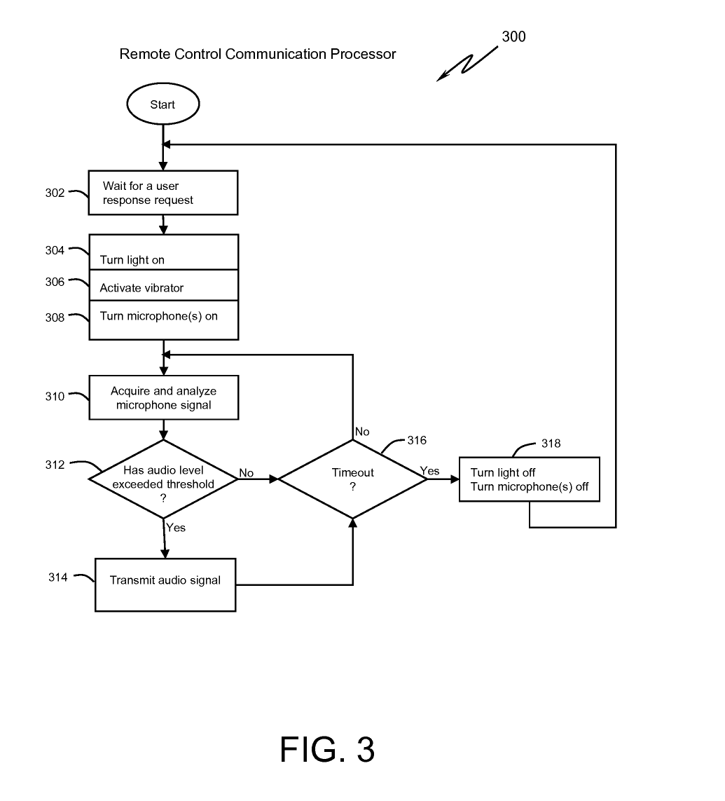

In one embodiment, the communication processor 156 implements the algorithm discussed below with respect to FIG. 3, but different algorithms may be implemented.

The buttons 152 allow the viewer to turn on or off the video display unit, change the video channel, the volume, or other aspects of the video as commonly known. The button presses are communicated to the video display unit 130 by the IR transmitter on the remote control 154 and are received by the IR receiver 136. In some cases, such as a request to change the channel, the signal is then further transferred from the video display unit 130 to the video receiver 120 where a different channel is then decoded for viewing.

The transceiver 160 and the transceiver 146 allow the local processor 140 and the communication processor 156 to communicate, and may use Bluetooth technology, wireless USB technology, WiFi technology, or other presently known or not yet known ways of communicating voice and digital signals. Using the transceivers 160 and 146 the local processor 140 instructs the communication processor 156 to turn on the microphones 158 and, if the remote control 150 is so enabled, to turn on the light 162 and to activate the vibrator 164 The instructions may also include timing information regarding how long to wait for an initial voice message to be received by the microphones 158 how long to wait once no voice message is received, or a total amount of time to wait before turning off the microphones 158 and, if present, the light 162.

The vibrator 164 provides a physical stimulus to the user who is holding the remote control and indicates that a response is requested. It may typically operate for approximately one second, although longer or shorter times may be used. The vibrator 164 may also generate frequencies that can be heard, and may include a small speaker, or may induce a sound when sitting on a hard surface.

The light 162 is typically turned on whenever the microphones 158 are enabled. It may be on steadily, or may flash a few times initially to draw the user's attention.

One or more microphones 158 are used to input an audio response from the user. A sound level threshold may be used to identify when the user is speaking More than one microphone, located in different portions in the remote control 150 may be used to help isolate the sound coming from the user's voice. For example, a microphone on the back of the remote control device 150 will pick up a substantially similar audio signal from the television, but would pick up a substantially reduced signal from the user's voice. By making linear or nonlinear combinations of the signals received by two or more microphones, the speaker's voice can be at least partially isolated from other sounds in the room. Using a variable gain, the energy of the background noise can be adaptively minimized, improving the isolation of the speaker's voice. Alternatively, a single directional microphone may be used; in a further alternative multiple directional microphones may be used.

A headend processor 170 comprises a digital signal processor, processor, ASIC or other device located on or associated with a network server. A packet-based (e.g., internet) connection 172 connects the local processor 140 with the headend processor 170. A database 174 is a digital storage medium.

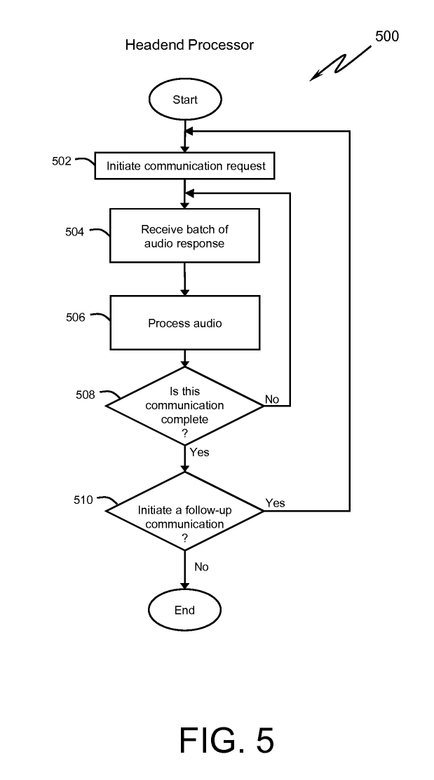

The headend processor 170 directs the transfer of messages, which it acquires from the database 174 over the connection 172 to the local processor 140. The headend processor 170 also receives the responses from the user via the local processor 140, which it then analyzes for content using speech recognition techniques and, optionally, for identification or authentication of the user. The database 174 may include digital patterns which can be used to aid the speech recognition, and may contain voice examples or voice characteristics to identify the identity or demographic properties of the speaker, using presently known or not yet developed techniques in the voice analysis art. Alternatively, a dedicated voice recognition engine 176 may perform such voice recognition. In some instances, voice recognition may have already been performed locally and will not need to be performed at the headend. A gateway 178 may be coupled to the processor 170 to enable communication with advertising and other partners. In one embodiment, the headend processor 170 implements the algorithm discussed below with respect to FIG. 5, but different algorithms may be implemented.

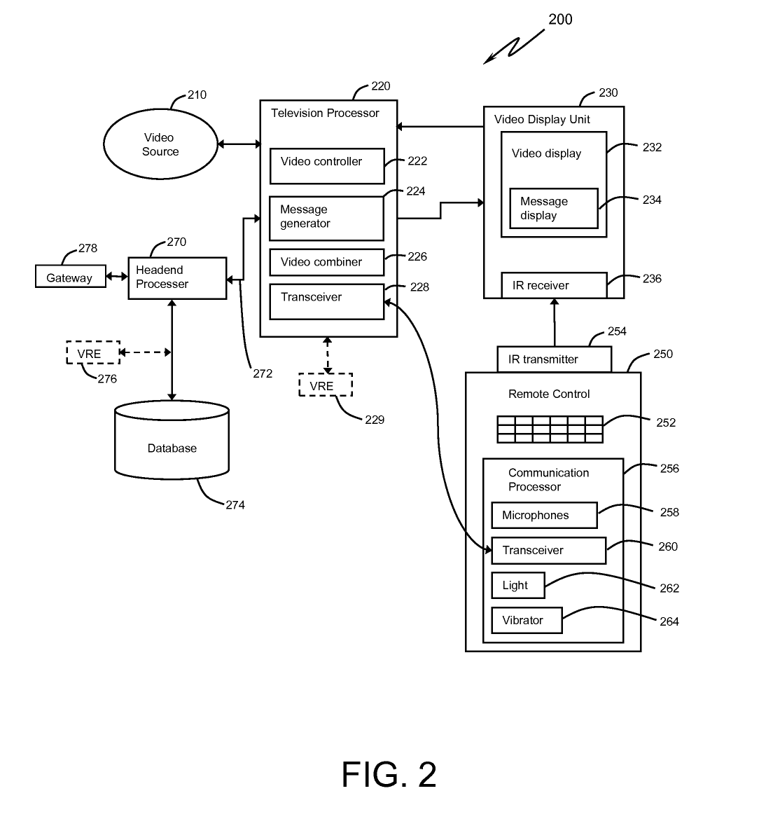

FIG. 2 shows another embodiment of a system 200 that enables viewer interactions. The system includes a packet-based (e.g., internet) video source 210, a packet-based (e.g, internet protocol) television processor 220, a video display unit 230, a remote control 250, a headend processor 270, a packet-based (e.g., internet) connection 272 and a database 274. An internet protocol (IP) television system (IPTV) is one example of a connectionless, packet-based media presentation system.

The video source 210 comprises any source of video which is transmitted from any computer or server using a local or wide area network, such as the internet, to another processor.

The television processor 220 comprises a processor suitable for processing video signals. It further comprises a video controller 222, a message generator 224, a video combiner 226, and a radio-frequency transceiver 228. The television processor 220 may be a single processor, or a series of processors.

The processor 220 may be coupled to an optional voice recognition engine, or voice recognizer, 229. The voice recognizer 229 may be dynamically programmed based on message-specific vocabulary transmitted with a message. Local voice recognition may permit text instead of actual voice data to be transmitted in the reverse direction (the forward direction being communication to the user). The text may correspond directly to a spoken voice response or may correspond only indirectly. For example, if an opinion poll presents choices A-D, if the user speaks information corresponding to choice A, instead of transmitting the corresponding text, only the letter A may be transmitted.

The television processor 220 receives the video signal from the video source 210. The video controller 222 performs any of a number of activities to receive and convert video data into a format suitable for viewing. For example, it may select the video data from a multitude of data received from the video source 210. The video controller 222 may communicate with any of a number of internet or other sources to direct which sources send video, either with the input of a user, or independently. The video controller 222 also formats the received video into a format that can be displayed on a video monitor.

The message generator 224 formats the message to be displayed into a video format, such as text of a particular size and font and color, which may be stationary or moving from frame to frame. The message may also include pictures or animations. The video combiner 226 combines the message video with the video from the video receiver to generate a single video presentation. The message video may be overlaid on the other video opaquely, or may be combined with some level of transparency.

The video display unit 230 comprises a video display 232 with a screen and speakers, or an acoustic output that can be connected to speakers. It may be a television, a computer monitor, or any other screen or video projection system that shows a sequence of images. A portion of the video display is used as a message display 234 region. The message display 234 may be limited to a small bar near the bottom of the screen, comprising approximately 10% to 20% of the height of the video display 232, or may encompass a smaller or larger portion of the display, including all of it. The video display unit 230 also contains an infrared (IR) receiver 236.

The remote control 250 includes buttons 252, an IR transmitter 254, a communication processor 256, one or more microphones 258, a radio-frequency transceiver 260, and optionally one or more of a light 262, such as a light emitting diode (LED), and a vibrator 264.

The buttons 252 allow the viewer to turn on or off the video display unit, change the video channel, the volume, or other aspects of the video as commonly known. The button presses are communicated to the video display unit 230 by the IR transmitter on the remote control 254, and are received by the IR receiver 236. In some cases, such as a request to change the channel, the signal is then further transferred from the video display unit 230 to the video controller 222, where a different channel is then decoded for viewing.

The transceiver 228 and the transceiver 260 allow the television processor 220 and the communication processor 256 to communicate, and may use Bluetooth technology, wireless USB technology, WiFi technology, or other presently known or not yet known ways of communicating voice and digital signals. Using the transceivers 228 and 260, the television processor 220 instructs the communication processor 256 to turn on the microphones 258, and, if the remote control 250 is so enabled, to turn on the light 262 and to activate the vibrator 264. The instructions may also include timing information regarding how long to wait for an initial voice message to be received by the microphones 258, how long to wait once no voice message is received, or a total amount of time to wait before turning off the microphones 258, and, if present, the light 262.

The vibrator 264 provides a physical stimulus to the user who is holding the remote control and indicates that a response is requested. It may typically operate for approximately one second, although longer or shorter times may be used. The vibrator 264 may also generate frequencies that can be heard, and may include a small speaker, or may induce a sound when sitting on a hard surface.

The light 262 is typically turned on whenever the microphones 258 are enabled. It may be on steadily, or may flash a few times initially to draw the user's attention.

One or more microphones 258 are used to input an audio response from the user. A sound level threshold may be used to identify when the user is speaking More than one microphone, located in different portions in the remote control 250, may be used to help isolate the sound coming from the user's voice. For example, a microphone on the back of the remote control device 250 will pick up a substantially similar audio signal from the television, but would pick up a substantially reduced signal from the user's voice. By making linear or nonlinear combinations of the signals received by two or more microphones, the speaker's voice can be at least partially isolated from other sounds in the room. Using a variable gain, the energy of the background noise can be adaptively minimized, improving the isolation of the speaker's voice. Alternatively, a single directional microphone may be used; in a further alternative multiple directional microphones may be used.

The communication processor 256 comprises a digital signal processor, processor, ASIC or other device for processing a request for user-directed communication (the request being received by the transceiver 260), controlling the microphones 258, light 262, and vibrator 264, identifying the audio response picked up by the microphones 258, and passing this information to the transceiver 260 to be sent back to the television processor 220.

A headend processor 270 comprises a digital signal processor, processor, ASIC or other device located on or associated with a network server. A packet-based (e.g., internet) connection 272 connects the television processor 220 with the headend processor 270. A database 274 is a digital storage medium.

The headend processor 270 directs the transfer of messages, which it acquires from the database 274, over the connection 272 to the television processor 220. The headend processor 270 also receives the responses from the user via the television processor 220, which it then analyzes for content using speech recognition techniques and, optionally, for identification or authentication of the user. The database 274 may include digital patterns which can be used to aid the speech recognition, and may contain voice examples or voice characteristics to identify the identity or demographic properties of the speaker, using presently known or not yet developed techniques in the voice analysis art. Alternatively, a dedicated voice recognition engine 276 may perform such voice recognition. In some instances, voice recognition may have already been performed locally and will not need to be performed at the headend. A gateway 278 may be coupled to the processor 220 to enable communication with advertising and other partners.

FIG. 3 illustrates an embodiment of an algorithm 300 by which the communication processor 156 can perform its function. Different, additional or fewer steps may be provided than shown in FIG. 3.

In step 302, the processor waits for a request from the transceiver 160 to obtain a response from the viewer. In step 304 the light is turned on, in step 306 the vibrator is activated, and in step 308 the microphone is turned on. In step 310, signal is acquired for a period of time from the one or more microphones and is analyzed. The analysis includes an assessment of the audio level, which is used in step 312 to decide if a predetermined threshold has been exceeded, indicating that an audio response has been received. The analysis of the signal in step 310 may also include a combining of signals from two or more microphones, where one or more signals is used to cancel the background noise in the room to improve the quality of the sound received from the person. This may enable the system to work even where there are loud voices being broadcast in the television program. If the audio level threshold has been exceeded, then the audio signal is transmitted in step 314. After the audio signal has been transmitted, or if the audio level threshold has not been exceeded, then step 316 determines if a timeout period has been exceeded. If no timeout period has been exceeded, then the algorithm continues to acquire and analyze signal. Once a timeout period has been exceeded, the light and microphones are turned off, as shown in step 318, and the processor returns to the state of step 302 where it waits for another request.

FIG. 4 illustrates an embodiment of an algorithm 400 by which the local processor 140 combines the video from the video source 110 with the message to be displayed. Different, additional or fewer steps may be provided than shown in FIG. 4.

As an initial step 402, the processor clears a video overlay buffer, removing any residual that may have resided in this buffer from a previous use. In step 404, video is streamed from the video receiver 120 into a video buffer. This streaming of video becomes a continuous step, which continues to run while the algorithm proceeds. In a next step, step 406, the processor waits for a communication request from the headend 170. In other embodiments, previously communication requests may be activated at a certain time of day, or after the video has been turned on for a certain amount of time, or based on the video program currently being shown, or based on other criteria specified and transmitted by the headend processor 170.

In step 408, the message is extracted and arranged into a format suitable for video display. For example, if the message is to be displayed is simple text, then step 408 may consist of applying a particular font, font size, and font color so that the message can be shown on the video display unit 130 in a desired format and structure. Furthermore, step 408 includes placing the message into a video overlay buffer, where it will be combined with the video program by the video combiner 144.

In step 410, the local processor 140 commands the transceiver 146 to send a user response request to the remote control transceiver 160. This request may include timing information about how long the microphones should be activated to listen for a response. In step 412 the audio from the remote control 150 is received and forwarded to the headend processor 170. This transmission may be conducted using packets, with packets being sent as soon as they are received, minimizing latency.

After the display of the video message is no longer needed, the video overlay is cleared, as shown in step 414.

FIG. 5 illustrates an embodiment of an algorithm 500 by which the headend processor 170 processes communications. Different, additional or fewer steps may be provided than shown in FIG. 5.

In step 502 the headend processor 170 initiates a communication request, which includes transmitting the message to be displayed on the television or video monitor. An amount of time to wait for a response may also be transmitted, or a default time, such as five seconds, or more or less than five seconds, may be used.

In step 504 audio response packets are received. They may or may not include all of the user's response. In step 506 the audio is processed, using voice recognition or other audio processing techniques as are currently or not yet known in that art, to interpret the audio response. The audio may also be processed to identify the speaker's identity, or a demographic of the individual, such whether the person is male or female or to determine his or her approximate age. The identification of the speaker may be used to tailor further messages, or even the content of the video itself. One message may ask the user to speak a specific word or phrase to aid in the speaker identification process. A message may ask the user to speak a word or phrase, to prevent the use of automated processes from simulating the response of a person. In this case, the word or phrase shown to the user may include an image of a word or phrase that would be difficult for an automated program to interpret, even using optical character recognition techniques, and the word or phrase would be different every time this technique is used.

In step 508 an evaluation is made as to whether or not the communication is complete. If not, the processor acquires more audio data as shown in step 504. If the communication is complete, the processor makes a decision, as shown in step 510, of whether or not to instigate a follow-up communication. The follow-up communication would be initiated as shown in step 502. If no follow-up is desired, the algorithm ends or returns to a waiting stage.

While the algorithms shown in FIG. 3, FIG. 4, and FIG. 5 have been described with respect to their application of the system 100 of FIG. 1, the same or similar, including substantively similar, algorithms may be implemented with respect to the system 200 of FIG. 2, as would be immediately known or readily conceived by one skilled in the art by applying the concepts taught with respect to the system of FIG. 1.

While the invention has been described above by reference to various embodiments, it will be understood that many changes and modifications can be made without departing from the scope of the invention. For example, some or all of the voice processing described as being done at the headend processor 170 may be performed by the local processor 140; message content and requests for communication from the headend processor 170 or headend processor 270 may be transmitted during off-peak hours for delayed use; the remote control 150 may communicate directly with the video receiver 120, the local processor 140, or the television processor 220; a viewer may be given incentives to respond to one or a series of messages; messages may be presented based on the video program that has been, is being, or will be presented; any of the processors may actually be a combination of processors being used for the described purposes; or messages presented to the user may include an audio component in addition to or in lieu of a text or video message.

It is therefore intended that the foregoing detailed description be understood as an illustration of the presently preferred embodiments of the invention, and not as a definition of the invention. It is only the following claims, including all equivalents that are intended to define the scope of the invention.

1.-24. (canceled)

25. A method of voice-interactive advertising using a textual forward channel and a voice reverse channel, comprising:
at a geographic location remote from a user, selecting a textual message to be presented to a user in conjunction with a media presentation, the textual message being selected based at least in part on prior interactions with the user through the textual forward channel and the voice reverse channel;
delivering the textual message to equipment at premises of the user;
delivering the media presentation to equipment at premises of the user;
presenting the textual message to the user in conjunction with the media presentation;
equipment at the premises of the user receiving a voice response to the textual message;
transmitting information derived from the voice response to a geographical location remote from the user; and
taking into account the information derived from the voice response when selecting a next textual message to be presented to the user.
